(19) United States
(12) Patent Application Publication
(10) Pub. No.: US 2024/0289458 A1
(43) Pub. Date: Aug. 29, 2024

(54) Method and Device Relating to Decision-Making Threshold

(71) Applicant: Telefonaktiebolaget LM Ericsson (PUBL), Stockholm (SE)

(72) Inventors: Joel Patrik Reijonen, KIRKKONUMMI (FI); Harri Pietilä, MARTTILA (FI)

(21) Appl. No.: 18/568,923

(22) PCT Filed: Jun. 11, 2021
(86) PCT No.: PCT/SE2021/050566

§ 371 Date: Dec. 11, 2023

(51) Int. Cl. G06F 21/56; G06F 21/57; H04L 9/40

(52) U.S. Cl. CPC G06F 21/566; G06F 21/577; H04L 63/1425

(57) ABSTRACT

A method for determining a Decision-Making Threshold, DMT, comprising obtaining environment threat data (104) comprising one or more events, each event associated with a label providing an indication of a threat event. The method further comprises obtaining the target metric scores (204); computing anomaly predictions relating to if the events are malicious or not and comparing the anomaly predictions with a DMT to obtain malicious threat predictions. The method further comprises computing current metric scores (303) for the environment threat data using at least the labels and the malicious threat predictions for the environment threat data; comparing the computed current metric scores with the target metric scores and adapting the DMT depending on if the computed metric scores are within a range of the target metric scores or not.

### TECHNICAL FIELD

The invention relates to techniques for determining a decision-making threshold. More specifically, the invention relates to a method, a device, a computer program and a computer program product.

### BACKGROUND

Security-related anomalies and threats are constantly evolving in emerging networks, such as in Internet of Things (IoT) and Fifth Generation (5G). Moreover, the number of connected devices is increasing significantly. In order to guarantee security of such devices, modern tools of automation are required to find suspicious patterns and remedy the impact of malicious attempts.

Network security related anomaly and threat detection using for e.g. machine learning, enable data-driven security analytics where inferences may be derived regarding benign and malicious behavior of the observed devices and networks. There are number of research contributions like in Marco A F Pimentel et. al, ‘A review of novelty detection’, Signal Processing, 99, 215-249, 2014 that propose utilization of various machine learning algorithms in novel anomaly detection, such as support vector machines, decision trees and neural networks. However, there seems to be limited research regarding decision-making, where the focus is on the interpretation of the anomaly detection results.

Commercial products, such as Splunk (https://www.splunk.com/), compute scores for observed samples indicating the probability of a threat and use thresholds to determine whether the observed sample is a malicious or benign sample. These thresholds use a pre-defined default value and are therefore less suitable for a dynamic environment involving threat events.

Another problem that is observed is the manual setting/changing of the threshold based on a particular use case. Manual setting of threshold results in higher costs associated with detecting a malicious event. For instance, setting too low threshold may result in higher number of False Positive (FP) detections, while setting too high thresholds may result in higher number of False Negative (FN) detections. A FP occurs when a benign event has falsely been identified as a threat event. A FN occurs when a threat event has falsely been identified as a benign event. A handheld device, such as a mobile phone, and an Internet of Things (IoT) device may produce inherently different traffic patterns, owing to reasons such as data traffic, how frequent they communicate, etc. Malicious operations of these different devices produce abnormal events with different characteristics, such as abnormal data traffic volumes. While an anomaly threshold of, say, 50 for the handheld device may be normal, the same anomaly threshold for the IoT device may be a critical signal of suspicious activity or security threat, due to that IoT devices may have lower threshold of say 20. In such cases, manual setting of a high threshold of 50 results in larger number of FNs for the IoT device, thus leading to higher costs in relation to threat detection and threatening the overall security of the network environment.

### SUMMARY

Existing solutions do not consider use-case specific characteristics of different devices operating in different communication networks to determine a decision-making threshold for detecting malicious events. Further, factors such as risk and cost values are not used to aid in decision-making of suspicious data patterns or threats. To overcome the problems stated above, the present invention enables improved selection of a decision-making threshold for detecting malicious events in a communications network.

An object of the invention is to enable enhanced security with reduced costs for a network environment communicating with different devices through automated and/or dynamic threshold selection for different types of devices, networks and network topologies.

According to a first aspect of the invention, there is provided a device for determining a Decision-Making Threshold, DMT, comprising one or more processor(s) and memory. The said memory contains instructions which when executed on the one or more processor(s) cause the device to obtain environment threat data comprising one or more events. Each event is associated with a label providing an indication of a threat event. Secondly, the device obtains one or more target metric scores. Thirdly, the device computes, for the one or more events of the environment threat data, one or more anomaly predictions relating to if the one or more events are malicious or not. The device further compares the one or more anomaly predictions with a DMT to obtain one or more malicious threat predictions. As a fourth step, the device computes one or more current metric scores for the environment threat data using at least the labels and the one or more malicious threat predictions for the environment threat data. As a fifth step, the device compares the computed one or more current metric scores with the one or more target metric scores and adapts the DMT depending on if the computed one or more metric scores are within a range of the one or more target metric scores or not.

According to a second aspect of the invention, there is provided a method for determining a DMT, the method comprises obtaining environment threat data comprising one or more events, each event associated with a label providing an indication of a threat event. The method further comprises obtaining one or more target metric scores. The method further comprises computing, for the one or more events of the environment threat data, one or more anomaly predictions relating to if the one or more events are malicious or not. The method further comprises comparing the one or more anomaly predictions with a DMT to obtain one or more malicious threat predictions. The method further comprises computing one or more current metric scores for the environment threat data using at least the labels and the one or more malicious threat predictions for the environment threat data. The method still further comprises comparing the computed one or more current metric scores with the one or more target metric scores and adapting the DMT depending on if the computed one or more current metric scores are within a range of the one or more target metric scores or not.

In an embodiment according to the first and the second aspect, the environment threat data is represented as a table consisting of one or more rows and one or more columns, each row representing the event and one column of the one or more columns representing the label.

In an embodiment according to the first and the second aspect, comprises indicating the threat event for the environment threat data if the label is 1.

In an embodiment according to the first and the second aspect, comprises obtaining the threat event which is generated by a function simulating threat data and inserting the threat event in the environment data.

In an embodiment according to the first and the second aspect, comprises obtaining the threat event which is generated by a dataset of real threat captures and inserting the threat event in the environment data.

In an embodiment according to the first and the second aspect, the threat event comprises one or more threats such as initial access, lateral movement, credential access and denial of service.

In an embodiment according to the first and the second aspect, the target metric score is calculated using one or more cost values, wherein the cost value comprises at least one of number of FPs relating to the event of the environment threat data, number of FNs relating to the event, cost of FPs relating to the event, cost of FNs relating to the event, cost of the threat event, probability of occurrence of the threat event, frequency of occurrence of the threat event, importance weight associated with the FPs and importance weight associated with FNs.

In an embodiment according to the first and the second aspect, the current metric score and the target metric score comprise at least one of the following metrics: precision, recall and F1 score, wherein each metric is calculated using at least one of number of FPs, number of FNs and number of True Negatives (TN).

In an embodiment according to the first and the second aspect, the F1 score is a harmonic mean of recall and precision.

In an embodiment according to the first and the second aspect, comprises computing the one or more malicious threat predictions using a single row in the table.

In an embodiment according to the first and the second aspect, comprises computing the one or more malicious threat predictions using multiple rows in the table.

In an embodiment according to the first and the second aspect, comprises computing the anomaly prediction by training a machine learning, ML, model with the environment threat data without one or more threat events.

In an embodiment according to the first and the second aspect, comprises computing the anomaly prediction based on a length of a leaf in a decision tree-based ML model.

In an embodiment according to the first and the second aspect, the anomaly prediction is a probability value that the event is malicious.

In an embodiment according to the first and the second aspect, comprises updating the DMT and repeatedly computing one or more current metric scores for the environment threat data using the updated DMT until the computed one or more current metric scores is within a range of said target metric scores 204, if the computed target metric score 204 is not within a range of said DMT.

In an embodiment according to the first and the second aspect, the range falls within a limit of the target metric scores 204.

In an embodiment according to the first and the second aspect, the adapting or the updating the DMT comprises selecting a new DMT.

In an embodiment according to the first and the second aspect, the new DMT is selected based on a criterion of achieving the highest recall and/or precision.

In an embodiment according to the first and the second aspect, the new DMT is selected based on a criterion of achieving the highest F1 score.

In an embodiment according to the first and the second aspect, achieving the highest F1 score comprises performing, within a time period, iterations of the current metric scores computation using different DMTs and selecting, from among the DMTs, a DMT that achieves the highest F1 score as the new DMT.

In an embodiment according to the first and the second aspect, the new DMT is selected based on at least one of risk, cost and time available for current metric score computation.

In an embodiment according to the first and the second aspect, the new DMT is selected in order to reduce the number of FPs in the anomaly detection.

According to a third aspect of the invention, there is provided a computer program, comprising instructions which, when executed on a device for determining a DMT, cause the device to carry out the method according to any of the embodiments mentioned above.

According to a fourth aspect of the invention, there is provided a computer program product comprising a computer readable storage means on which a computer program according to the third aspect is stored.

### BRIEF DESCRIPTION OF THE DRAWINGS

FIG. 1 illustrates a flow chart to obtain environment threat data according to an embodiment of the invention

FIG. 2 illustrates a flow chart to obtain one or more target metric scores according to an embodiment of the invention

FIG. 3 illustrates a flow chart to obtain a decision-making threshold according to an embodiment of the invention

FIG. 4 illustrates a method for determining a decision-making threshold according to an embodiment of the invention

FIG. 5 illustrates a method according to an embodiment of the invention

FIG. 6 illustrates a device for determining a decision-making threshold according to an embodiment of the invention

FIG. 7 illustrates a device for determining a decision-making threshold according to an embodiment of the invention

### DETAILED DESCRIPTION

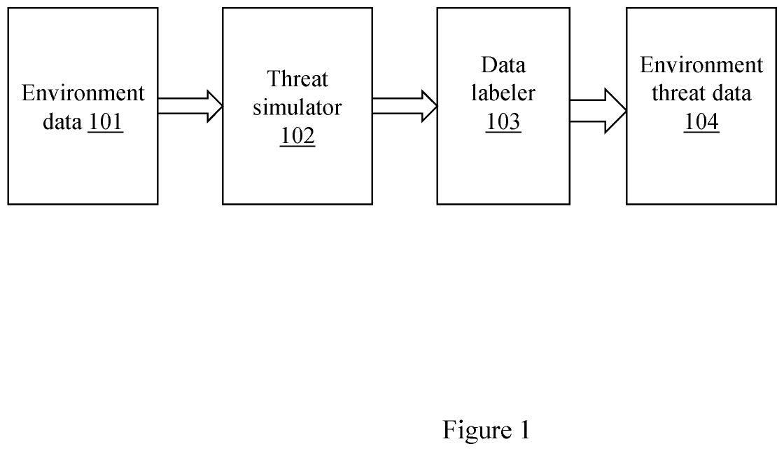

FIG. 1 illustrates different components required to obtain an environment threat data 104. According to FIG. 1, the environment data 101 may be a raw data that may be obtained from a given environment. In some cases, the environment data 101 may be a raw data of/for a given environment. A definition of the environment is a surrounding, real and/or virtual, where a user can observe the status, e.g threats, of the environment, observe one or more entities associated with the environment and take preventive and/or corrective actions. As an example, the environment can be a managed network of an enterprise, where user is a security analyst, a person, or a computer, and an entity is a connected device. Here, the user can deny connectivity from the device if the device demonstrates harmful behavior to the environment, e.g., hoarding all the capacity in connectivity. The user may be an agent that can observe and take actions within the environment. This user can for instance monitor network events, i.e. observe, and mitigate fishy subscriptions, i.e. take action.

The environment data 101 may, for instance, be 6G networking data, 5G networking data, Long-Term Evolution (LTE) data, wireless communication data including Vehicular communication data, IoT networking data in relation to an IoT environment. The environment data 101 may, additionally, refer to normal usage data in the environment such as IoT traffic data or system usage data. As an example, the environment data 101 may be represented as a key-value pair as follows: environment data 101={timestamp: 2021-01-01 09:01:21, sent_volume: 105, received_volume: 3452, number of failed login attempts: 2, etc.}. In an embodiment, the environment data 101 is represented in a table, e.g. Table 1 as shown below.

TABLE 1
Environment data with threat event and label 101

| | | | | Number of | Label |
|---|---|---|---|---|---|
| | | | | failed | (Data |
| | | | Re- | login | labeler |
| | Timestamp | Sent_volume | ceived_volume | attempts | 103) |
| 1 | 2021-01-01 | 105 | 3452 | 2 | 0 |
| | 09:01:21 | | | | |
| 2 | 2021-01-01 | 103 | 4031 | 1 | 0 |
| | 09:02:34 | | | | |
| 3 | 2021-01-01 | 90 | 67530 | 35 | 1 |
| | 10:12:51 | | | | |
| 4 | 2021-01-01 | 104 | 12345 | 0 | 0 |
| | 11:21:30 | | | | |
| 5 | 2021-01-01 | 208 | 5421 | 0 | 0 |
| | 11:45:26 | | | | |
| 6 | 2021-01-01 | 102 | 2001 | 0 | 0 |
| | 13:45:35 | | | | |
| 7 | 2021-01-01 | 103 | 23456 | 1 | 0 |
| | 14:20:00 | | | | |
| 8 | 2021-01-01 | 104 | 4354 | 0 | 0 |
| | 17:00:05 | | | | |
| 9 | 2021-01-01 | 106 | 3331 | 2 | 0 |
| | 19:39:15 | | | | |
| 10 | 2021-01-01 | 105 | 3789 | 0 | 0 |
| | 21:05:51 | | | | |

A threat simulator 102 is employed to introduce into the environment data 101 one or more threat events which are malicious. The threat simulator 102 may simulate the one or more threat events or use real threat captures. Simulate may refer to generating representative data for a threat event type based on information of a threat event. The real threat capture refers to a collection of one or more events from real environment with real threat events and can consist of any type of threat types and related data. The real threat capture may, for example, be brute force login attempts, software vulnerability exploitation, or any other security incident type. The simulated threat event may, for example, be a cybersecurity threat event. The purpose of inducing one or more threat events into the environment data 101 is to enable evaluating anomaly detection by calculating precision, recall and/or F1 scores using a particular threshold which requires knowledge about the true malicious events, as will be further disclosed below and through-out the present application.

The threat simulator 102 may use a function to simulate one or more threat events and further add them to the environment data 101. An advantage of simulating one or more threat events and introducing them in the environment data 101 is that real threat captures, e.g. volumetric flood, brute-force login attempt, software vulnerability, etc. are sensitive-information and often not available for use. Table 1, row 3, and further shown below for the sake of simplicity illustrates an example of a threat event that is simulated and introduced into the environment data 101 and.

| | | | | Number of | Label |
|---|---|---|---|---|---|
| | | | | failed | (Data |
| | | | Re- | login | labeler |
| | Timestamp | Sent_volume | ceived_volume | attempts | 103) |
| 3 | 2021-01-01 | 90 | 67530 | 35 | 1 |
| | 10:12:51 | | | | |

In this case, the simulated threat event floods the environment with very high volumes of data i.e. 67530, over and above a normal data volume sent and received, e.g. 25000, in the environment. Additionally, the particular threat event at row 3 has a higher number of failed login attempts i.e. 35 compared to other events. However, the threat events so simulated and injected into the environment data may not in reality be as obvious as depicted above. In general, elaborated technology may be needed to identify real world malicious threat events as discussed further in this application. Thus, the simulated threat events injected need to, as much as is possible, emulate real world threats to accurately imitate a real-world situation.

Data labeler 103 of FIG. 1 labels the threat events introduced into the environment data 101, with a label. In other words, the label is used to indicate one or more threat events in the environment data 101. In some embodiments, the threat event may be simulated as explained above in relation to the threat simulator 102. The label may be appended to the environment data 101. In some embodiments, the label may be appended to each row in the environment data 101 as illustrated in Table 1. The label may be associated with one or more events comprised in the environment data 101. In some embodiments, the label has a numeric value of 1 indicating a threat event, or a malicious event, while the label having a value of 0 indicates a normal event, referred to as a benign event, as can further be seen in Table 1.

In some embodiments, the label comprises different non-zero values based on different threat event types. For instance, a label value of 0 indicates a benign event while a label value of 1 indicates a volumetric flood threat event type and a label value of 3 indicates a Denial of Service threat event type.

While labelling, i.e. to label one or more events, is illustrated as being carried out automatically at the data labeler 103, it would be appreciated by a skilled person that the labelling may be carried out in other different ways. For instance, a manual labelling may be performed by a security analyst who labels real and/or simulated traces of events with a label to indicate a threat event or a benign event. In a second way, labelling may be performed at the time of simulating one or more threat events by a simulation function similar to the one as described in relation to the threat simulator 102. The label provided by the data labeler 103, either automatic or manual labelling, is a ground truth label against which a predicted label is compared.

The environment threat data 104 is the environment data comprising one or more events such as the threat events and/or benign events, wherein each event of the environment threat data 104 is associated with a label indicating whether the event is a threat event or a benign event. The threat event may be a simulated threat event introduced into the environment data 101. In an embodiment, the environment threat data 104 is represented in/as a table as illustrated in Table 1 above. As an example, the environment threat data 104 may be included in messages of type, JavaScript Object Notation, JSON, over Hypertext Transfer Protocol, HTTP, POST, or in any suitable message format known to the skilled person.

Herein ends the procedure for generating the environment data with one or more threat events and including the label.

For better understanding of subsequent literature, it is important to note that the following four scenarios occur upon analyzing the environment threat data 104, and upon further predicting the presence of one or more threat events.
False Positive (FP)—An FP occurs when an event is a benign event but has falsely been identified as a threat event.
False Negative (FN)—An FN occurs when an event is a threat event but has falsely been identified as a benign event.
True Positive (TP)—A TP occurs when an event is a threat event and has correctly been identified as a threat event
True Negative (TN)—A TN occurs when an event is a benign event and has correctly been identified as a benign event

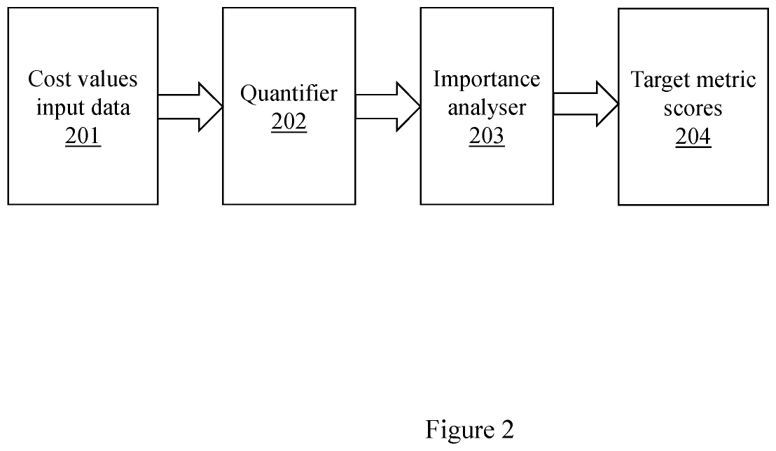

FIG. 2 illustrates components required to obtain target metric scores 204. The procedure starts with receiving input data namely Cost Values Input Data (CVID) 201. The CVID 201 may be received from a user in the environment, e.g., a security analyst monitoring a communication network system, or one or more end-devices, e.g. an IoT device communicating within a communication network. The CVID 201 comprises any combination of cost values and risk values associated with identifying anomalous events in an environment.

The handling of anomalous events, both malicious and benign may cause an impact, e.g. security breach due to undetected threat event, on the environment. The cost value refers to the impact that the detected anomalous event has on one or more resources, for example energy consumption or money.

In detail, the cost value may, for example, include but not limited to one or more of the following:
An estimated cost of FP—The cost of processing a detected anomalous event which turns out to be benign, e.g. the cost of a security alert or a raising a threat event.
An estimated cost of FN—The cost associated with an undetected incident or threat event.

A threat event may have different costs associated with different threat event types such as Denial of Service (DOS), Initial Access (IA), Lateral Movement (LM), Credential Access (CA) or Volumetric Flooding (VF). DoS is a threat event type that impacts the environment by disrupting or denying a service to a user. IA is a threat event type wherein a malicious user gains an initial access to the environment. LM is a threat event type wherein after the initial access, the malicious user moves to a different system within the environment and adversely affects the system. CA is a threat event type where a malicious user gains access to one or more user credentials. VF is a type of DoS event, where the disruption is caused by massive amounts of traffic to a target, wherein a target could be any system in the environment. While in some embodiments the cost of FN includes the cost of a particular threat event type, in some other embodiments, the cost of FN and the cost of a threat event type are calculated separately.

Further, the risk value may refer to a likelihood of the threat event taking place. The risk value may, for example, include but not limited to one or more of the following:
Number of FPs-A FP may be a risk value due to extensive cost of analyzing to determine that an event is not a threat event.
Number of FNs-A FN may be a risk value due to extensive cost of the impact of the security breach resulting from not identifying that an event is a threat event.

In addition to risk and costs, the CVID 201 may include the following parameters:
Importance weight-Value in percentage used to indicate importance of occurrence of FP and/or FN in relation to how much of FP and/FN may be tolerated in the environment. Range is 0 to 100%
   Importance weight of FPs
   Importance weight of FNs
Frequency of occurrence of a threat event—For an environment exposed to a large number of threat events, frequency should be high and vice versa. Further, the frequency of occurrence of a threat event may be defined relative to another threat event.
Probability of occurrence of a threat event

The CVID 201 comprising the risk and the cost values, is then fed into a quantifier 202. The quantifier 202 estimates an extent of security threat that may be tolerated in an environment. The extent of security threat that may be tolerated may be relational. For example, the environment may tolerate 1000 FP per year if the cost of 1000 FP is much lower than 1 FN.

To better illustrate how the quantifier 202 estimates the extent of security threat that may be tolerated, consider, as an example, a DoS attack threat event type in an environment. Let us assume that we have the following CVID 201 values: Cost of false negative (C_{FN})=200000, Cost of false positive (C_{FP})=2000, total number of False detections=(number of FPs+number of FNs). The total number of False detection can, for instance, be estimated based on the average number of false detections in a year or in some case, provided by a security analyst. In this example, the total number of false detections is considered as 1000.

The quantifier 202 estimates the tolerance limit of number of FPs and number of FNs for the DOS attack as follows:

$$Tolerance limit of number of FNs = {C}_{FN} * ( number of FPs + number of FNs ) / ( {C}_{FN} + {C}_{FP} ) = 99.0099 * 1000 = 990 ( rounded - off to the nearest decimal )$$

$$Tolerance limit of number of FPs = {C}_{FP} * ( number of FPs + number of FNs ) / ( {C}_{FN} + {C}_{FP} ) = 0.9901 \% * 1000 = 10 ( rounded - off to the nearest decimal )$$

If the number of FNs exceed 99.0099% of the total number of false event detections, then it would be too costly to process the FNs owing to the high costs associated with processing a FN. Same is true for C_{FP} and FP. In other words, over the tolerance limit of FP and FN, the one or more threat events would be too costly to be processed.

Alternatively, the quantifier 202 outputs the FP and FN tolerance limit by minimizing the Cost Function (CF) such as below. CF indicates the total cost that is distributed among the FP and

FN detections and is estimated as follows:

$$CF = ( {FN}_{DoS} * {C}_{FN} + {C}_{FP} * {FP}_{DoS} )$$

Where CF is the cost function to be minimized, FN_{DoS} is the number of False Negative associated with the e.g. DoS threat event, FP_{DoS} is the number of False Positive associated with the DoS threat event, C_{FN} is the cost of false negative associated with the DoS threat event and C_{FP} is the cost of false positive associated with the DoS threat event. The FP and FN tolerance limit may vary depending on different threat event types and the CVID 201 values associated with the threat events.

Based on the CVID 201 and tolerance limit of FP and FN, an importance analyzer 203 assigns importance weights to the number of FPs and number of FNs. The importance weight is a value between 0% and 100% indicating importance of detecting or not detecting a threat event with respect to costs associated with processing or not processing the threat event. In some embodiments, the importance weight is defined manually, eg by a security analyst, based on an organization's definition of CVID 201 and the tolerance limits of FP and FN.

To better illustrate the assignment of importance weight, an example is provided. Assume that the FP and FN tolerance limit are defined according to the following example condition: Condition: If the number of FNs is more than 5 per 100 events or if the number of FPs is more than 90 per 100 events, then the total cost is too much for an organization to handle.

The objective is, thus, to balance the costs of FPs and FNs and not to reduce the total costs as such. This is done by reducing the number of costly events while allowing a higher number of cheap or less costly events. For example, the cost for a FN detection can be balanced by identifying the detection as a TP.

It may, thus, be observed that the importance weight of FN is very high in comparison to importance weight of FP implying the system needs to be rather sensitive in handling a missed threat event. This requires choosing a high importance weight for an FN and a low importance weight for FP. However, it may be noted that the importance weight of FP may increase if the frequency of occurrences of FP increases.

The target metric scores 204 to be achieved are, thus, obtained based on the information provided by the CVID 201, the quantifier 202 and the importance analyzer 203. The target metric scores 204 comprise one or more scores such as F1 score, henceforth referred to as F1, precision and recall. The target metric scores 204 depict the fitness of the system performance. More specifically, precision is the ratio of correctly predicted threat events to all predicted threat events. Precision indicates the percentage of real threat events out of all predicted threat events. Recall is the ratio of correctly predicted threat events to all threat events. Recall indicates the percentage of predicted threat events out of all threat events. F1 is the inverse of the average of inverses of Precision and Recall.

$$Target Precision , target recall and target F 1 metric scores are calculated below :$$

$$Target Precision = ( number of TPs ) / ( number of TPs + tolerance limit of number of FPs )$$

$$Target Recall = ( number of TPs ) / ( number of TPs + tolerance limit of number of FNs )$$

$$Target F 1 = 2 * ( precision * recall ) / ( precision + recall )$$

In an embodiment, the number of TPs is the average number of correctly detected threat events in a year. Alternatively, the number of TPs may be estimated manually by a security expert. The tolerance limit of number of FPs is obtained according to one or more procedures described above in relation to the quantifier 202. Further, the tolerance limit of number of FNs is obtained according to one or more procedures described above in relation to the quantifier 202.

In some embodiments, an organization, a system in an environment or a security analyst, may set a requirement of the target metric scores 204. For example: minimum Precision=0.09 (or 9%), minimum Recall=0.99 (or 99%) and minimum F1=0.165 (or 16.5%).

In such above embodiments, the precision, the recall and the F1 target metric scores may be calculated in accordance with the formula for precision, recall and F1 provided above.

In some embodiments, the precision is further multiplied by an importance weight of FP. The importance weight of FP may be obtained according to one or more procedures described above in relation to the importance analyzer 203. Additionally, the recall is further multiplied by an importance weight of FN. The importance weight of FN may be obtained according to one or more procedures described above in relation to the importance analyzer 203. Additionally, the F1 score is calculated based on the importance weight-adjusted precision and recall target metric scores. This embodiment has an advantage that it enables estimating the optimal decision-making threshold (DMT) by using an organization's threat event detection requirements, i.e. importance of FP vs FN.

Herein ends the procedure for computing the target metric scores 204.

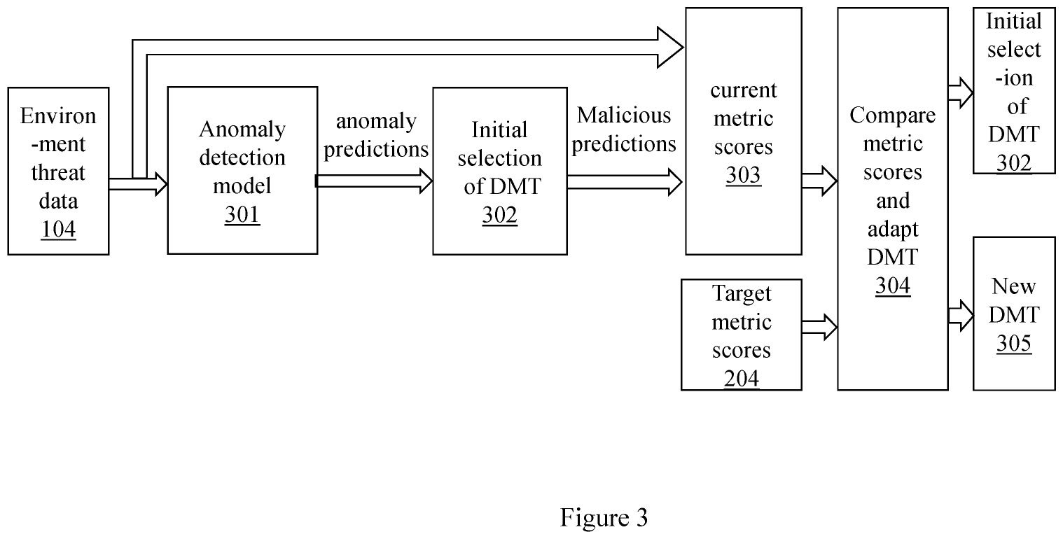

FIG. 3 illustrates different components required to obtain a DMT for detecting one or more threat events. The environment threat data 104 as described above in reference to FIG. 1 is fed to an Anomaly Detection Model (ADM) 301. The ADM 301 may be used to perform prediction, for each event comprised in the environment threat data 104, to determine if the event is malicious, i.e. threat event, or benign. The one or more predictions obtained as output from the ADM are hereby referred to as anomaly predictions or anomaly scores. Typically, the anomaly prediction or score is normalized as a real value between 0 and 100.

In an embodiment, the ADM may be a Machine Learning (ML) model which is trained using the common methods in the art of ML. For instance, it is conceivable to use both supervised and unsupervised training using environment data obtained. It should be noted that the model should be trained with data obtained from a similar environment as the data that the model should be used on for predictions, but it should not be the same data.

In an embodiment, one or more anomaly predictions are computed and updated in a table such as table 2 as shown below as an example. See column ‘Anomaly prediction/anomaly score’

TABLE 2
Anomaly predictions from ADM and malicious threat predictions with an initial DMT = 67

| | | | | | Label | Anomaly | |
|---|---|---|---|---|---|---|---|
| | | | | Number of | (Data | prediction/ | Malicious |
| | | | | failed login | labeler | anomaly | threat |
| | Timestamp | Sent_volume | Received_volume | attempts | 103) | score | predictions |
| 1 | 2021-01-01 | 105 | 3452 | 2 | 0 | 24 | 0 |
| | 09:01:21 | | | | | | |
| 2 | 2021-01-01 | 103 | 4031 | 1 | 0 | 55 | 0 |
| | 09:02:34 | | | | | | |
| 3 | 2021-01-01 | 90 | 67530 | 35 | 1 | 87 | 1 |
| | 10:12:51 | | | | | | |
| 4 | 2021-01-01 | 104 | 12345 | 0 | 0 | 65 | 0 |
| | 11:21:30 | | | | | | |
| 5 | 2021-01-01 | 208 | 5421 | 0 | 0 | 66 | 0 |
| | 11:45:26 | | | | | | |
| 6 | 2021-01-01 | 102 | 2001 | 0 | 0 | 34 | 0 |
| | 13:45:35 | | | | | | |
| 7 | 2021-01-01 | 103 | 23456 | 1 | 0 | 68 | 1 |
| | 14:20:00 | | | | | | |
| 8 | 2021-01-01 | 104 | 4354 | 0 | 0 | 25 | 0 |
| | 17:00:05 | | | | | | |
| 9 | 2021-01-01 | 106 | 3331 | 2 | 0 | 26 | 0 |
| | 19:39:15 | | | | | | |
| 10 | 2021-01-01 | 105 | 3789 | 0 | 0 | 25 | 0 |
| | 21:05:51 | | | | | | |

In an embodiment, the anomaly prediction is a probability that the event is malicious.

In an embodiment, the one or more anomaly predictions may be computed based on a length of a leaf in a decision tree-based ML model. In the tree-based ML model, one or more events are categorized by successively splitting the samples using one or more features and one or more split values. The amount of splits needed to have just the event left can be used as an indicator of anomaly of the event. Trees are typically randomized and collected into forests. The resulting average length to the leaf can be used as an anomaly score.

While, a single ADM may be employed for computing one or more anomaly predictions, in some embodiments, multiple ADMs may be employed. In such embodiments where multiple ADMs are employed multiple anomaly predictions are calculated for each environment threat data 104. As would be described further below, multiple malicious threat predictions are obtained by comparing the multiple anomaly predictions against an initial selection of DMT as illustrated by 302 of FIG. 3. The multiple malicious threat predictions and the environment threat data 104 are used to compute multiple metric scores i.e one metric score set for each ADM, which would further enable the selection of the optimal DMT.

The one or more anomaly predictions are compared against an initial selection of DMT 302, herein referred to as initial DMT 302, to obtain one or more malicious threat predictions or malicious predictions. A DMT such as initial DMT 302 is used to distinguish between a malicious event and a benign event. The DMT is a threshold for identifying the one or more malicious threat predictions. Referring to Table 2 as an example, an initial DMT=67 is selected. An anomaly prediction or an anomaly score below this initial DMT is evaluated as a benign event, i.e. 0) and that above the DMT as a malicious event, i.e. 1.

In an embodiment, two or more DMTs, e.g. initial DMTs, may be used per ADM. Further, a DMT may be used per threat event type, e.g. DoS, IA.

In an embodiment, the initial DMT 302 may be selected from a list of pre-defined DMTs.

In an embodiment, the one or more malicious threat predictions may be computed using one or more rows of a table such as table 2 above.

As illustrated by current metric scores 303 of FIG. 2, the malicious threat predictions and the environment threat data 104, i.e. environment data with one or more threat events and associated label, are used to compute one or more current metric scores 303. The current metric scores 303 may be at least one of F1, precision and recall. The precision, recall and F1 current metric scores are calculated as below:

$$Precision = ( number of TPs ) / ( number of TPs + number of FPs )$$

$$Recall = ( number of TPs ) / ( number of TPs + number of FNs )$$

$$F 1 = 2 * ( precision * recall ) / ( precision + recall )$$

In an embodiment, the current metric scores 303 may be computed by using information in a table such as table 2. Referring to Table 2 as an example, Number of TPs, number of FPs and number of FNs are calculated by comparing the values in columns “label” and “malicious threat predictions”.

number of TPs=1, number of FPs=1, number of FNs=0;

thus giving the following current metric scores 303: precision=0.5, i.e. 50%, recall=1, i.e. 100%, F1=0.6667, i.e. 66.67

According to the compare metric scores and adapt DMT 304 of FIG. 3, the computed current metric scores 303 are compared with the target metric scores 204 to determine if the computed current metric scores 303 fall within a range of values of the target metric scores 204.

If they fall within the range, the initial DMT 302 is selected as the threshold to be used for anomaly detection. If the current metric scores 303 do not fall within a range of values of the target metric scores 204, then a new DMT 305 is selected and updated for computing the current metric scores 303.

Referring to the example presented above in relation to Table 2, an initial DMT 302 of 67 is selected. The current metric scores 303 are calculated to be precision=0.5 i.e. 50%, recall=1 i.e. 100%, F1=0.6667 i.e. 66.67%. Suppose the target metric score 204 is obtained, e.g. from an organization or a system in an environment or a security analyst or based on computing from the CVID values, as follows: minimum Precision=0.09 or 9%, minimum Recall=0.99 or 99% and minimum F1=0.165 or 16.5%. Since the current metric scores 303 calculated above fall within the range of the target metric scores 204, the initial DMT 302 is selected as the threshold to be used for anomaly detection.

However, the target metric scores 204 may in some cases be obtained, e.g. from an organization or a system in an environment or a security analyst or based on computing from the CVID values, with stricter requirements as shown in the following example: minimum Precision=0.99 or 9%, minimum Recall=0.99 or 99% and minimum F1=0.165 or 16.5%. Since, in this case, the current metric scores 303 do not fall within the range of the target metric scores 204, a new DMT 305 is selected as the threshold to be used for anomaly detection. The new DMT 305 may be selected from a list of DMTs. The list of DMTs may be the same as the initial list of DMTs from which the initial DMT 302 was selected. In an embodiment, the initial DMT 302 and the new DMT 305 may be selected from 2 different lists.

Referring to Table 2, as an example, the DMT is adapted by selecting a new DMT 305 of 68. This enables the new current metric scores with the new DMT to be precision=1 i.e. 100%, recall=1 i.e. 100%, F1=1 i.e. 100% which is now within the range of the target metric scores. The range of the target metric scores may, for instance, be 60-100 for recall, 50-100 for precision and 55-100 for F1.

The DMT may be adapted by selecting a new DMT 305. The new DMT 305 can be selected based on the following different criteria. In an embodiment, the new DMT 105 is selected which satisfies a criterion of obtaining the highest recall and/or precision. In another embodiment, the new DMT 305 is selected which satisfies a criterion of obtaining the highest F1 score. The highest F1 score may the one obtained by carrying out multiple iterations of current metric scores computations using different DMTs within a time period and wherein a DMT for which the highest F1 score is achieved is selected as the new DMT 305. Additionally, or alternatively, the number of iterations may be pre-defined. In yet another embodiment, the new DMT 305 is selected based on risk, cost and/or time available for computation. In yet another embodiment, the new DMT 305 may be selected to reduce the number of FPs in the anomaly detection.

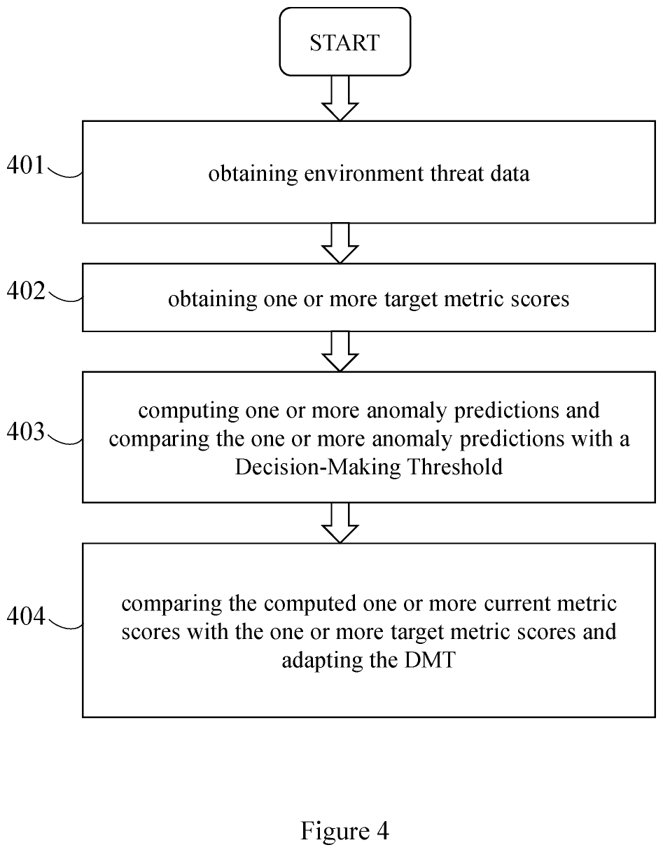

FIG. 4 illustrates a method for determining a DMT, performed by the device 700 according to an embodiment of the present invention. The method comprises:
Step 401 obtaining environment threat data comprising one or more events, each event associated with a label
Step 402 obtaining one or more target metric scores 204
Step 403 computing one or more anomaly predictions and comparing the one or more anomaly predictions with a DMT to obtain one or more malicious threat predictions
Step 405 comparing the computed one or more current metric scores 303 with the one or more target metric scores 204 and adapting the DMT depending on if the computed one or more current metric scores 303 are within a range of the one or more target metric scores 204 or not

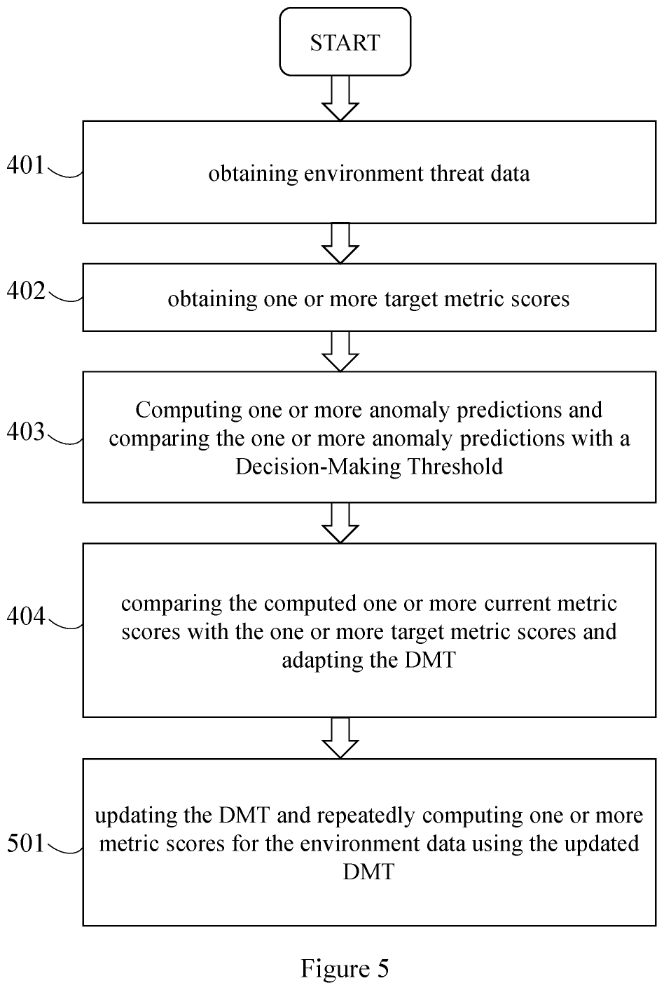

FIG. 5 illustrates a method for determining a DMT, performed by the device 700 according to another embodiment of the present invention.
Step 401 obtaining environment threat data comprising one or more events, each event associated with a label
Step 402 obtaining one or more target metric scores 204
Step 403 computing one or more anomaly predictions and comparing the one or more anomaly predictions with a DMT to obtain one or more malicious threat predictions
Step 404 comparing the computed one or more current metric scores 303 with the one or more target metric scores 204 and adapting the DMT depending on if the computed one or more current metric scores 303 are within a range of the one or more target metric scores 204 or not
Step 501 updating the DMT and repeatedly computing one or more metric scores for the environment threat data using the updated DMT until the computed one or more current metric scores 303 is within a range of said target metric scores 204, if the computed target metric scores 204 is not within a range of said DMT

Referring to Step 402, the one or more target metric scores 204 may be obtained in a message, for example, of type JSON over HTTP POST, or in any suitable message format known to the skilled person. Further, the one or more target metric scores 204 may be obtained from a device implementing the functions or methods or components described in relation to FIG. 2. Additionally, or alternatively, the one or more target metric scores 204 may be configured in the device 700 by a security analyst. Further, the security analyst may configure the one or more target metric scores based on the methods described in relation to FIG. 2.

Referring to Step 501, updating the DMT refers to a new selection of DMT to compute new current metric scores 303 which are further compared against the target metric scores 204. Thus, the DMT is iteratively updated until the current metric scores 303 fall within a range of values of the target metric scores 204. The range of the target metric scores may, for instance, be 60-100 for recall, 50-100 for precision and 55-100 for F1. The DMT value for which the current metric scores 303 fall within the range of the target metric scores 204 is selected as the threshold for anomaly detection.

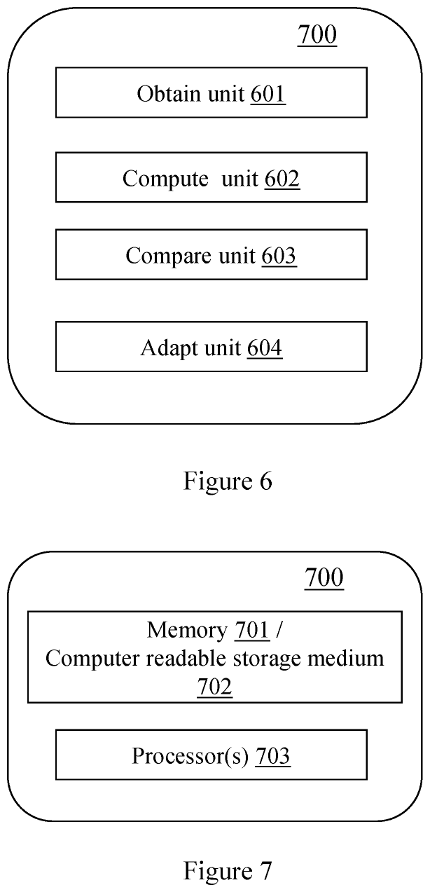

FIG. 6 illustrates the device 700 for determining a DMT comprising
An obtain unit 601 configured to obtain environment threat data comprising one or more events, each event associated with a label and/or one or more target metric scores
A compute unit 602 configured to compute one or more anomaly predictions and compare the one or more anomaly predictions with a DMT to obtain one or more malicious threat predictions
A compare unit 603 configured to compare the computed one or more current metric scores 303 with the one or more target metric scores 204
An adapt unit 604 configured to adapt the DMT depending on if the computed one or more current metric scores 303 are within a range of the one or more target metric scores 204 or not

It may be noted that the adapt unit 604 may further be configured to update the DMT and repeatedly compute one or more current metric scores 303 for the environment threat data using the updated DMT until the computed one or more current metric scores 303 is within a range of said target metric score 204, if the computed target metric score 204 is not within a range of said DMT.

It may also be noted that, although, the compute unit 602 is configured to compare the one or more anomaly predictions with a DMT to obtain one or more malicious threat predictions, alternatively, the compare unit 603 may be configured to perform the compare the one or more anomaly predictions functionality above, in addition to the compare unit 603 functionality.

In general terms, each functional unit 601-604 i.e. the obtaining unit 601, the compute unit 602, the compare unit 603 and the adapt unit 604, may be implemented in hardware or in software. Preferably, one or more or all functional units 601-604 may be implemented by the one or more processors 703, possibly in cooperation with the computer readable storage medium 702 or the memory 701. The one or more processors 703 may thus be arranged to fetch instructions, from the computer readable storage medium 702 or the memory 701, as provided by a functional unit 601-604 and to execute these instructions, thereby performing any steps of the device 700 as disclosed herein.

FIG. 7 illustrates a device 700 for determining the DMT, comprising one or more processor(s) 703 and memory 701. The memory 701 contains instructions which when executed on the one or more processor(s) 703 cause the device 700 to obtain environment threat data comprising one or more events, each event associated with a label providing an indication of a threat event; obtain one or more target metric scores 204; compute, for the one or more events of the environment threat data, one or more anomaly predictions relating to if the one or more events are malicious or not, and compare the one or more anomaly predictions with a DMT to obtain one or more malicious threat predictions; compute one or more current metric scores 303 for the environment threat data using at least the labels and the one or more malicious threat predictions for the environment threat data; and compare the computed one or more current metric scores 303 with the one or more target metric scores 204 and adapt the DMT depending on if the computed one or more current metric scores 303 are within a range of the one or more target metric scores 204 or not.

The device 700 according to FIG. 7 may have storage and/or processing capabilities. The device 700 may include one or more processors 703 and a memory 701 or a computer readable storage medium 702. In particular, in addition to a traditional processor and memory, the device 700 may comprise integrated circuitry for processing and/or control, e.g., one or more processors and/or processor cores and/or Field Programmable Gate Array (FPGAs) and/or Application Specific Integrated Circuitry (ASICs) adapted to execute instructions. The processor(s) 703 may be configured to access, e.g., write to and/or read from) the memory 701 or the computer readable storage medium 702, which may comprise any kind of volatile and/or nonvolatile memory, e.g., cache and/or buffer memory and/or Random Access Memory (RAM) and/or Read-Only Memory (ROM) and/or optical memory and/or Erasable Programmable Read-Only Memory (EPROM).

The device 700 may be configured to control any of the methods and/or processes described herein and/or to cause such methods, and/or processes to be performed. Processor 703 corresponds to one or more processors 703 for performing device 700 functions described herein. The device 700 includes memory 701 or computer readable storage medium 702 that is configured to store data, programmatic software code and/or other information described herein. The memory 701 or the computer readable storage medium 702 may include instructions which, when executed by the one or more processors 703, cause the one or more processors 703 perform the processes described herein with respect to the device 700. The instructions may be software (SW) or computer program associated with the device 700.

Thus, the device 700 may further comprise SW or computer program, which is stored in, for example, the memory 701 or the computer readable storage medium 702 at the device 700, or stored in external memory, e.g., database, accessible by the device 700. The SW or computer program may be executable by the one or more processors 703.

A computer program product in the form of a computer readable storage medium 702 may comprise any form of volatile or non-volatile computer readable memory including, without limitation, persistent storage, solid-state memory, remotely mounted memory, magnetic media, optical media, RAM, ROM, mass storage media, for example: a hard disk, removable storage media for example: a flash drive, a Compact Disk (CD) or a Digital Video Disk (DVD), and/or any other volatile or non-volatile, non-transitory device readable and/or computer-executable memory devices that store information, data, and/or instructions that may be used by one or more processors 703. Computer readable storage medium 702 may store any suitable instructions, data or information, including a computer program, software, an application including one or more of logic, rules, code, tables, etc. and/or other instructions capable of being executed by one or more processors 703. Computer readable storage medium 702 may be used to store any calculations made by one or more processors 703. In some embodiments, one or more processors 703 and computer readable storage medium 702 may be considered to be integrated.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1.-46. (canceled)

47. A device for determining a Decision-Making Threshold, DMT, comprising one or more processor(s) and memory, said memory containing instructions which when executed on the one or more processor(s) cause the device to:
obtain environment threat data comprising one or more events, each event associated with a label providing an indication of a threat event;
obtain one or more target metric scores;
compute, for the one or more events of the environment threat data, one or more anomaly predictions relating to if the one or more events are malicious or not, and compare the one or more anomaly predictions with a DMT to obtain one or more malicious threat predictions;
compute one or more current metric scores for the environment threat data using at least the labels and the one or more malicious threat predictions for the environment threat data; and
compare the computed one or more current metric scores with the one or more target metric scores and adapt the DMT depending on if the computed one or more metric scores are within a range of the one or more target metric scores or not.

48. The device according to claim 47, wherein the environment threat data is represented as a table consisting of one or more rows and one or more columns, each row representing the event and one column of the one or more columns representing the label.

49. The device according to claim 47, comprising one or more processor(s) and memory, said memory containing instructions which when executed on the one or more processor(s) cause the device to:
indicate the threat event for the environment threat data if the label is 1;
obtain the threat event which is generated by a function simulating threat data and inserted in the environment data; and/or
obtain the threat event which is generated by a dataset of real threat captures and inserted in the environment data.

50. The device according to claim 47, wherein the threat event comprises one or more threats such as initial access, lateral movement, credential access and denial of service.

51. The device according to claim 47, wherein:
the target metric score is calculated using one or more cost values, wherein the cost value comprises at least one of number of false positives relating to the event of the environment threat data, number of false negatives relating to the event, cost of false positives relating to the event, cost of false negatives relating to the event, cost of the threat event, probability of occurrence of the threat event, frequency of occurrence of the threat event, importance weight associated with the false positives and importance weight associated with false negatives.

52. The device according to claim 47, wherein the current metric score and the target metric score comprise at least one of the following metrics: precision, recall and F1 score, wherein each metric is calculated using at least one of number of False Positives, number of False Negatives and number of True Negatives.

53. The device according to claim 52, wherein the F1 score is a harmonic mean of recall and precision.

54. The device according to claim 47, comprising one or more processor(s) and memory, said memory containing instructions which when executed on the one or more processor(s) cause the device to:
compute the one or more anomaly predictions using a single row in the table; or
compute the one or more anomaly predictions using multiple rows in the table.

55. The device according to claim 47, comprising one or more processor(s) and memory, said memory containing instructions which when executed on the one or more processor(s) cause the device to:
compute the anomaly prediction by training a machine learning, ML, model with the environment threat data without one or more threat events.

56. The device according to claim 47, comprising one or more processor(s) and memory, said memory containing instructions which when executed on the one or more processor(s) cause the device to compute the anomaly prediction based on a length of a leaf in a decision tree-based ML model.

57. The device according to claim 47, wherein the anomaly prediction is a probability value that the event is malicious.

58. The device according to claim 47, comprising one or more processor(s) and memory, said memory containing instructions which when executed on the one or more processor(s) further cause the device to update the DMT and repeatedly compute one or more current metric scores for the environment threat data using the updated DMT until the computed one or more current metric scores is within a range of said target metric scores, if the computed target metric scores is not within a range of said DMT.

59. The device according to claim 47, wherein the range falls within a limit of the target metric scores.

60. The device according to claim 47, comprising one or more processor(s) and memory, said memory containing instructions which when executed on the one or more processor(s) cause the device to adapt or update the DMT by selecting a new DMT.

61. The device according to claim 60, wherein the new DMT is selected based on:
a criterion of achieving the highest recall and/or precision; or
a criterion of achieving the highest F1 score.

62. The device according to claim 61, wherein achieving the highest F1 score comprises performing, within a time period, iterations of the current metric scores computation using different DMTs and selecting, from among the DMTs, a DMT that achieves the highest F1 score as the new DMT.

63. The device according to claim 60, wherein the new DMT is selected based on at least one of risk, cost and time available for current metric score computation.

64. The device according to claim 60, wherein the new DMT is selected in order to reduce the number of false positives in the anomaly detection.

65. A method for determining a Decision-Making Threshold, DMT, wherein the method is performed by a device, the method comprising:
obtaining environment threat data comprising one or more events, each event associated with a label providing an indication of a threat event;
obtaining one or more target metric scores;
computing, for the one or more events of the environment threat data, one or more anomaly predictions relating to if the one or more events are malicious or not, and comparing the one or more anomaly predictions with a DMT to obtain one or more malicious threat predictions;
computing one or more current metric scores for the environment threat data using at least the labels and the one or more malicious threat predictions for the environment threat data; and
comparing the computed one or more current metric scores with the one or more target metric scores and adapting the DMT depending on if the computed one or more metric scores are within a range of the one or more target metric scores or not.

66. A computer program product comprising a computer readable storage means on which a computer program is stored, wherein the computer program comprises instructions which, when executed on a device for determining a Decision-Making Threshold, cause the device to carry out the method according to claim 65.
